(19) United States
(12) Patent Application Publication
(10) Pub. No.: US 2005/0110702 A1
(43) Pub. Date: May 26, 2005

(54) Collapsible display device and methods for using the same

(76) Inventors: Paul Masami Aoki, Foster City, CA (US); Allison Gyle Woodruff, Foster City, CA (US)

Correspondence Address: Charles A. Rattner, Apt. 7, 240 Wardwell St, Stamford, CT, 06902-5254, US

(21) Appl. No.: 10/719,300

(22) Filed: Nov. 21, 2003

(51) Int. Cl. G09G 3/00

(52) U.S. Cl. 345/30

(57) ABSTRACT

Flexible display membranes are provided in various geometries in which a display area may be expanded to an operable position and collapsed to a smaller area for storage. In various configurations, the display membrane may be provided in general polygon or rounded shapes having one or more individual collapsible sections.

### FIELD OF THE INVENTION

The present invention relates generally to electric systems and devices, and relates more particularly to displays for electronic and computer devices.

### BACKGROUND OF THE INVENTION

Portable electronic devices, such as laptop and notebook personal computers, and in particular hand-held electronic devices, such as portable televisions, personal digital assistants, cellular telephones, satellite telephones, and electronic document readers, are all typically produced with displays that are limited in visual area. In most cases, the display area is limited by the (usually small) size of the portable electronic device itself. This is particularly true where the display is integrated with the body of the portable electronic device.

Since many of these devices generally do not require the same high-performance graphics capabilities of larger electronic and computing devices, and since until recently hand-held electronic devices provided a more limited or focused array of functions, the design limitations of display size were not considered significant. However, the complexity of portable electronic devices has been rapidly growing since the mid-1990's. Many hand-held device technologies are now converging, with a resulting increase on the functional demands of such devices so that the size of an available display now acts as a limitation on the ease with which multiple new functionalities can be presented to a user.

Accordingly, it would be desirable to provide larger display configurations to portable electronic devices, without impacting their portability and ease of use, in order to more readily accommodate greater device functionality. A larger display size would also accommodate larger font and graphic presentations than in present systems.

There exist several previous attempts to provide displays that can be expanded to a greater area. FIG. 1 shows a known “roll-up” configuration for a display in which a display area 102 is stored by rolling it tightly around a spring-actuated cylinder within a protective casing 100. Similar to roll-up projection screens, the bottom edge of the display area 102 may be pulled from the protective casing 100, thus unrolling the display area 102. Upon securing the display area 102 at a predetermined length, visual information may be presented thereon to a user.

It should be noted that the roll-up configuration has the advantage of expanding for use and collapsing to a smaller area for storage, making it potentially useful for portable electronic devices as one way to increase available display area. However, the area to which it collapses is still limited in its degrees of freedom by its constant width, as is the area to which it expands. That is, although the display area can be changed in its length dimension, its width dimension is generally fixed. Thus, if such a configuration were provided for portable electronic devices, the constant width would still be a limitation on display size. In addition, such roll-up configurations generally have display areas that are flexible (so that it may be rolled up without affecting performance) and unsupported, relying on gravity and proper orientation to maintain a constant display area. The unsupported flexibility of such a display makes it inconvenient for use in portable electronic devices that are typically used in a wide range of orientations. A mechanical supporting device can be used to ameliorate this problem, as described in U.S. Pat. App. 20020070910, in which a scaffold-like supporting device extends along the plane of the display as it is unrolled. However, such scaffolding adds cost and mechanical complexity.

FIG. 2 shows another variety of display configuration referred to collectively as “fold-out” displays. A first such configuration 200 includes multiple non-deformable panel sections 201, each attached edgewise to one or more parallel axes 202, such as hinges, which open and close similar to books. Each panel section 201 may include an individual display area or a portion of a larger display area. In a configuration 200 where three display panels 201 form the display area, the display area may be collapsed to a smaller area by rotating the top panel about a first parallel axis 202 from an open position, in which it is substantially aligned with a center panel, to a closed position, in which it faces the center panel. The top and center panel sections may then be rotated about a second parallel axis in a similar manner to close with the remaining bottom panel section. This will be referred to as an “aligned-axis” fold-out panel configuration because all of the axes or hinges are substantially parallel to each other. U.S. Pat. No. 6,262,785 describes a computer with an aligned-axis fold-out display using two panel segments.

A second fold-out display configuration 210 includes multiple panel sections 201 which are attached to one or more parallel axes 212, or to one or more additional axes 214 that are substantially perpendicular to the parallel axes 212. A given panel in the fold-out display configuration 210 may be attached edgewise to between one and four of its neighboring panels. This will be referred to as a “multiple-axis” fold-out panel configuration because not all of the axes or hinges are substantially parallel to each other. U.S. Pat. No. 6,008,220 describes a computer with a multiple-axis fold-out display using four panel segments.

FIG. 3 shows further variations of fold-out display configurations, such as an accordion-like aligned-axis folding display 300 in which at least two panels are collapsed back-to-back.

In any fold-out configuration, the panel sections 201 are generally rigid and can not themselves be individually deformed, bent, folded or collapsed. The area to which the display area can be collapsed or expanded is therefore limited by the dimensions of an individual panel section 201. In particular, aligned-axis displays are subject to the same expansion limitation as roll-up displays in that the length of the display can be increased (where length here means the dimension perpendicular to the aligned axes) but the width of the display can not (where width here means the dimension parallel to the aligned axes). In addition, multiple-axis displays can not be readily collapsed or expanded in a single action. That is, each panel, or row of panels, must generally be rotated individually between the open and closed positions, thus adversely impacting the ease of use of such configurations.

Accordingly, it would be advantageous to introduce display configurations that overcome certain disadvantages of existing technologies.

### SUMMARY OF THE INVENTION

It is an object of the present disclosure, therefore, to describe various features of a collapsible display device and methods of using the same. In particular, one aspect of the disclosure includes a method and apparatus in which a deformable display membrane, such as an electric or electronic paper, has one or more sections that are bended, folded, twisted or otherwise deformed about at least one axis. The axis may coincide with a support member, such as a rib or support arm. When a section is collapsed about its respective axis, the collapsed section forms a first geometric shape having a first, smaller area. When the collapsed section is expanded about the axis, the expanded section forms a second geometric shape having a second area greater than the first area.

In various embodiments of the present disclosure, the first geometric shape may be a different shape than the second shape. For example, when all sections of the display device are expanded or fully-extended, the display device may be any of a variety of fan shapes. When each section is then collapsed, the display device may form a second shape, such as a rectangle that occupies a smaller area. In such manner, the entire display, as well as its individual sections, are expanded and collapsed to occupy two distinct areas. Geometries other than fan shapes may be used, such as general polygons or oval shapes.

In further embodiments, the first and second geometric shapes may be similar or identical, although the area of the first collapsed configuration will still occupy a smaller area than the second expanded configuration. For example, the first and second shapes may both be the same class of arcuate shapes, such as circles, ovals or ellipses, but with differing diameters.

In additional embodiments, the display device may have an operable visual display area that is less than or substantially equal to the area of the expanded display device. Furthermore, each collapsible section of the display may contain all or a portion of the total display area. The display area may also be a different shape than the display device itself. For example, an expanded display device may be fan-shaped and the display area may be rectangular, in order to conform with current standard display configurations.

In still further embodiments, the display device may be provided separately or may be integrated with any of the following: a portable electronic device, a wireless receiver, or any other type of device for providing display instructions thereto. When expanded, the display device may be greater in length and/or width than the electronic device to which it is attached. When collapsed, the display device may be partially or fully retracted into the attached electronic device. An integrated display device may be provided in various orientations with the electronic device, and may extend from a side or corner thereof. An electronic device may also include more than one such integrated display. Alternatively, the display device may receive display instructions remotely, such as by wireless signal, or may include a display wand or the like to activate the display.

In various embodiments, the collapsible display device may be fully expanded and collapsed with a single physical action. For example, one or more buttons or other controls may be provided for collapsing and expanding the deformable sections.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is an illustration of an existing roll-up display;

FIGS. 2 and 3 are illustrations of existing fold-up display configurations;

FIG. 4 is an illustration of an exemplary deformable electronic display membrane for use with the present disclosure;

FIG. 5 is an illustration of a folding fan configuration for a display;

FIG. 6 is an illustration of brisé fan configuration for a display;

FIG. 7 is an illustration of various configurations of a fan-shaped display according to certain embodiments of the present disclosure;

FIG. 8 is an illustration of further embodiments of a fan-shaped display extending from a corner of an electronic device;

FIG. 9 is an illustration of various rectangular visual display areas on a fan-shaped display;

FIG. 10 is an illustration of various embodiments of dual fan-shaped displays for an electronic device;

FIG. 11 is an illustration of alternate embodiments of a folding display;

FIG. 12 is an illustration of a twist up configuration for a display;

FIG. 13 is an illustration of an expanded umbrella configuration for a display;

FIG. 14 is an illustration of a collapsed umbrella configuration for the display of FIG. 13; and

FIG. 15 is an illustration of a display wand for use with a collapsible display.

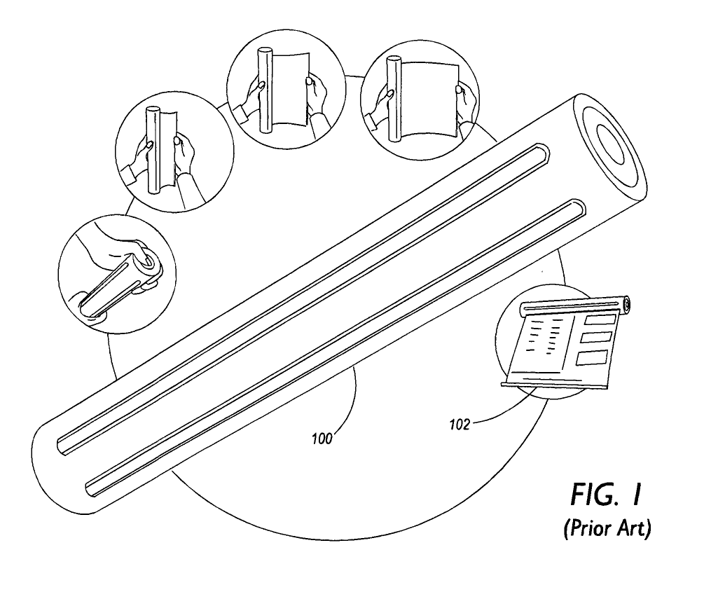

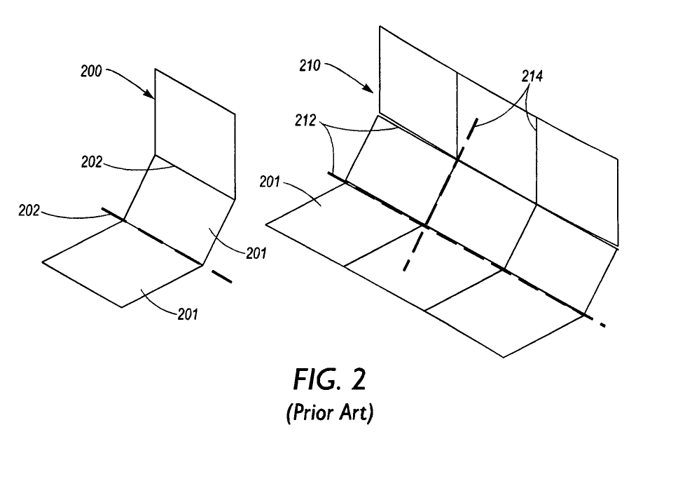

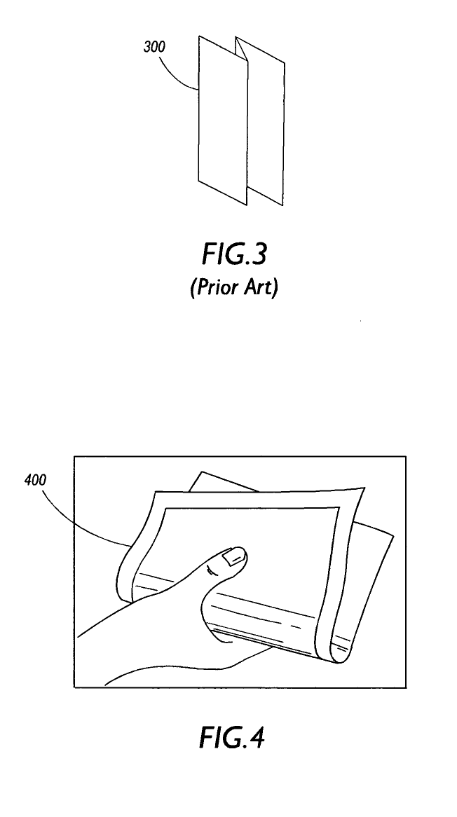

### DETAILED DESCRIPTION OF THE SPECIFIC EMBODIMENTS

Referring now to FIGS. 4-15, wherein similar components of the present disclosure are referenced in like manner, various embodiments of a collapsible display will be more particularly described.

In order for a collapsible display membrane to be operable, it must be sufficiently rigid so as to provide a constant display area, yet sufficiently flexible so as to allow individual sections of the display to be bended, folded, twisted, collapsed or otherwise deformed, where required. FIG. 4 shows one embodiment of a deformable display membrane 400, which may be deformed without unduly impairing its ability to display information when later expanded.

The membrane 400 will generally be built upon a layer of material that constitutes a structural substrate for the other components of the display membrane. The material must have thermal characteristics (such as melting point) and chemical characteristics such that it will withstand the fabrication processes of the various components of the display membrane that are built on top of it. The structural substrate material must also have mechanical properties that are suitable to the kind of deformation required by the specific display embodiment. The membrane 400 may accordingly include one or more structural substrate layers made of any of the following: a low elasticity material, such as a metal foil; and a high elasticity material, such as a plastic or polymer.

In certain embodiments, the membrane 400 may include control layer components and addressing circuitry for addressing the display pixels that form a visual display area along the display membrane 400. In conventional display systems, individual circuit elements used in the addressing circuitry are often not fabricated in a manner that is suited for building collapsible displays. For example, construction of active-matrix liquid-crystal displays (LCDs), such as those commonly used as personal computer monitors, typically involves a fabrication process for building thin-film transistor (TFTs) in which silicon is deposited on thin glass sheets. The glass has thermal and chemical characteristics that are desirable for that fabrication process, but the glass sheets are at best semirigid. As another example, commercial displays have been built using bi-stable dielectric twisting-ball (gyricon) display elements. Many of these displays have been direct-addressed using large-area copper pads on conventional printed circuit boards (PCBs); the copper pads are driven using off-board control logic.

PCBs are inexpensive but are entirely rigid. However, several alternative display control technologies are available such that the individual circuit elements (1) are themselves reasonably flexible and (2) can be fabricated using processes suitable for use with flexible structural substrates. There are a variety of such technologies, such as: amorphous silicon transistors fabricated at low-temperature, including those previously developed by PRINTED TRANSISTOR, INC.; polysilicon transistors fabricated at low-temperature, including those developed by FLEXICS, INC.; organic transistors, including those developed by LUCENT TECHNOLOGIES; and hybrid organic/inorganic transistors, including those developed by IBM. The ability to include transistor elements within a flexible control layer enables the use of active-matrix techniques, which are important if the display layer technology is not bi-stable (see below). Other available components for the control layer will be readily apparent to one of skill in the art.

In further embodiments, the membrane 400 may include display layer components for activating or deactivating an addressed pixel. The display layer elements must be built from materials that are flexible and can be fabricated on flexible substrates. If a control layer is present in the display, the display layer must be controlled by addressing circuit elements that are themselves flexible and can be fabricated on flexible substrates. As previously mentioned, conventional LCDs are typically associated with rigid or semirigid control layer implementations. The display layer components may include one or more of the following: organic light-emitting diodes (OLEDs), including those developed by PRINTED TRANSISTOR, INC.; polymer dispersed liquid crystal (PDLC) displays, such as those developed by LUCENT TECHNOLOGIES; dielectric twisting-ball displays, including the gyricon technology described in U.S. Pat. No. 4,126,854; and electrophoretic displays, such as those developed by E INK CORP. Such display technologies are often colloquially described using names such as “electric paper,” “electronic paper,” or “electronic ink.” Of these technologies, those in which the display elements are bi-stable (hold their image without the application of additional power) are often advantageous in that (1) they facilitate the construction of electronic devices with lower power consumption and therefore longer battery life, and (2) they do not need active-matrix elements to maintain their image. Other available components for the display layer will be readily apparent to one of skill in the art.

In any of the embodiments described below, the display membrane 400 may be provided as a single continuous sheet, or may be provide in physically-discrete sections that are aligned to provide the appearance of a continuous display. In embodiments where the display membrane 400 is continuous, individual sections of the display membrane 400 may be identified by points or axes about which they are deformed, collapsed, or the like. Where the display membrane is provided in physically discrete sections, various technologies may be provided to conceal, mask or hide otherwise visible edges of the sections within the display area. U.S. Pat. No. 5,734,513 describes one such technique that may be adapted. In addition to hardware-based edge concealment techniques, software-based techniques can be used to reduce the effect (as perceived by the end user) of having multiple display sections with visible edges between them. For example, U.S. Pat. No. 5,835,090 describes how the position of application windows in a graphic user interface (GUI) can be constrained to always be displayed entirely within one of several display sections if desired. Similarly, U.S. Pat. No. 6,008,220 describes how typographic layout of text can be adjusted to prevent individual characters from being split across multiple display sections.

Although various useful display membranes 400 have been developed and continue to be improved, there have not been many attempts to provide such display membranes 400 in configurations that allow the display to be expanded to larger areas and collapsed to smaller areas. In particular, there have not been proposed various geometries that would be useful for providing larger display areas to portable electronic devices. Most flexible display membranes 400 instead are proposed in the form of single panel displays, roll-up displays, aligned-axis fold-up panel displays, or multiple-axis fold-up panel displays, as discussed previously.

However, there are a variety of alternative geometries that are now possible with the advent of flexible display membranes 400, many of which were not possible or feasible with prior rigid display technologies. Such geometric configurations readily allow for one or more sections of a display area to be expanded to an open or operating position and readily collapsed to a compact, smaller area for storage or the like. In such configurations, the sections may collapse from one geometric configuration to a smaller geometric shape. In certain of these embodiments, the entire display itself collapses from one geometric shape to a shape of smaller area while individual sections of the display may not be deformed. In certain embodiments, the expanded and collapsed shapes may be of the same geometric class, or may be distinct geometric shapes. Area as used herein refers to the area occupied by the exterior shape of a collapsible display when viewing the display head-on. It should be readily appreciated that the volume of the collapsible display changes, as well as its area.

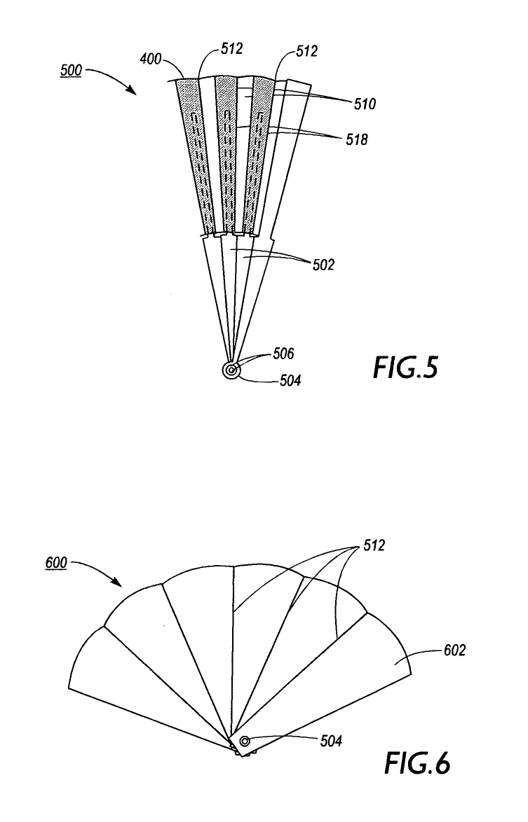

Various of the available geometries for a collapsible display will now be particularly described with respect to FIGS. 5-14 below. In various embodiments, the shape of a collapsible display in its fully-extended configuration may include one or more of the following: a general polygon, a convex polygon, a concave polygon, a star polygon, a wedge, a fan shape, and an arcuate, oval, elliptical, circular, or other regular or irregular rounded shapes. One of skill in the art will readily appreciate that many other geometries may likewise be used.

Such geometries may be readily adapted for stand-alone use or for use with an integrated electronic device. In various embodiments, an expanded display may extend from a side or corner of the integrated electronic device. A collapsed display may also be partially- or fully-retractable into the casing or body of an integrated electronic device for storage. Various geometries allow the collapsible display to expand to an area greater than that of the integrated electronic device, or in which the display area is greater in at least two dimensions (such as length and width) than the integrated device. Where the display and the electronic device are integrated, the display may be in a fixed orientation on the device, or may be allowed to tilt or yaw via appropriate attachment devices. Hardwired connections for video and power between the display and the integrated device may be provided in any of a variety of manners.

In the various embodiments described herein, the collapsible display may readily collapse or expand with a single action, such as a single hand motion. This is an advantage relative to known techniques, such as multiple-axis fold-up displays, in which many separate unfolding actions must be taken to expand the display. Alternatively, one or more controls, such as a button, can be provided to expand or collapse the display by activating appropriate actuators, electrical motors, spring-loaded mechanisms and the like. In such cases, the reduced number of actions required to collapse or expand the display is advantageous in that it may reduce the number of actuators, thereby improving reliability and reducing manufacturing cost. Controls may also be provided to lock the display in a fully expended or a fully collapsed position.

FIG. 5 shows a first available configuration 500 for a collapsible display, referred to herein as a “folding fan” configuration. Displays in the folding fan configuration 500 may be readily expanded and collapsed in a single motion, similar to known folding paper hand fans.

The folding fan configuration 500 includes one or more support members 502, such as rigid ribs or arms. Any number of such support members 502 may be provided, however, it would be beneficial to include as few support members as are needed to properly support the display membrane 400, thus reducing design complexity and cost.

In general, the support members 502 substantially overlap at one end where they are attached at a common pivot point 504 by a connector 506, such as a rivet, a ball-joint, or the like. In certain embodiments, one or more support members may rotate about separate pivot points (not shown). The support members 502 may, in certain embodiments, include a narrow extension 518 for supporting one or more sections 510 of the deformable display membrane 400. Alternatively, the support members 502 may support the sections 510 of the display membrane 400 substantially along their entire length.

The support members 502 are each rotatable about the pivot point 504 between a common collapsed position of compact area to a separate second radial position, where the display membrane 400 is fully expanded to its maximum area to form the folding fan configuration 500. When each of the support members 502 are in the collapsed position, individual sections 510 of the display membrane 400 are collapsed along one or more axes 512. When expanded to their separate second radial positions, sections 510 have substantially opposite ends that form an oblique angle relative to each other; the sections 510 point in separate radial directions and are not parallel to each other or to the common axis 512.

The fact that the display sections 510 have these substantially opposite ends that form an oblique angle relative to each other is what allows the folding fan collapsible display to achieve a compact collapsed configuration. It allows each of the individual display sections 510 to have substantially the same shape while folding easily along their respective common axes 512 as the supports 502 are rotated around pivot point 504. Note that there are many simple variations on the shape depicted in FIG. 5 for the display sections 510 that operate in essentially the same way. For example, if each display section 510 were to be extended further down the support member 502, making its lower end closer to the pivot point 504, the extended display section 510 would then have a substantially triangular shape. While in this case it could be argued that such a shape has no “opposite” ends in the most literal sense (since it would appear to have three sides), it is obvious that this extended shape operates in the same way as the shape depicted in FIG. 5. The reason for this is that the two ends that are adjacent to the pivot point 504 form the same oblique angle as in FIG. 5, even though the end closest to the pivot point 504 has been moved closer to pivot point 504 and made much shorter.

FIG. 5 illustrates the following additional point. In FIG. 5, every other display sections 510 is supported by a rib section 518 of a support member 502. The other display sections 510 are not supported by a rib 518. It can be seen that as the support members 502 are spread to expand the display, the unsupported display sections 510 are simultaneously rotated 180 degrees around both common axes 512—in short, each unsupported display section 510 is flipped over as the folding fan display is opened. Hence, the unsupported display sections 510 rotate entirely out of the plane of the display and then back into the plane of the display. In addition to this rotation with respect to the plane of the display, some amount of material flexing occurs as well. In opening a folding fan, the rotation of the unsupported display sections will generally cause the support members 502 to flex out of the plane of the display to some degree while the fan is opened. However, since the support members 502 produce some mechanical resistance to this flexing, the display sections 510 are forced to flex as well. Both flexing forces are relieved as the rotation of the unsupported display section 510 is completed. Analogous effects occur in reverse as the folding fan display is closed.

FIG. 6 shows a second possible fan configuration 600, referred to herein as a “brisé fan” configuration in which a plurality of non-deformable panel sections 602 are connected to a common pivot point 504. The panel sections 602 may each support a non-deformed section of a visual display. As with the folding fan configuration 500, when the brisé fan configuration 600 is collapsed, the panel sections 602 substantially overlap in a common lateral position. However, unlike the folding fan configuration 500, the panel sections 602 do not individually collapse.

The expanded brisé fan configuration 600 also has similar attributes to the expanded folding fan configuration 500. For example, in both, a fan-shaped geometry of larger area is formed when each section is expanded, then reduced when the configurations are collapsed. Also, when in an expanded configuration, non-adjacent ends of adjoining panel sections 602 are not parallel to each other or to a common axis 512 formed by their adjacent ends.

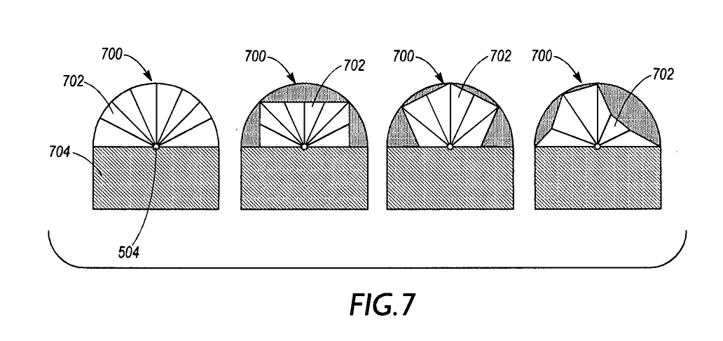

FIG. 7 shows additional expanded fan display configurations 700 that may be used for a collapsible display. In general, fan-shaped collapsible displays are most usefully provided in any shapes that are instances of the class of star polygons (in which there exists a specific point within the polygon that can be connected to any other point within the polygon by an imaginary line segment that lies wholly within the polygon), which includes as a special case the class of fan polygons (in which a fully-connected edge-point can be connected to any other point within the polygon by an imaginary line segment that lies wholly within the polygon). Many variations of such star polygons can be used, such as any one or more of the following classes of geometries: convex polygons (in which any point within the polygon that can be connected to any other point within the polygon by an imaginary line segment that lies entirely within the polygon), concave polygons (in which there exist a pair of points within the polygon that can not be connected by an imaginary line segment that lies wholly within the polygon), and variants bounded by curved edges instead of straight edges, such as circles, ellipses, ovals and semicircles. Non-fan-polygon shapes may also be used, but such shapes typically include unsupported corner points that would form hanging flaps, which are clearly undesirable for portable display applications. Alternatively, the hanging flaps would require an assortment of additional supports that would adversely impact design complexity.

In various embodiments, the display configuration 700 has an actual display area 702 that is less than or equal to the entire area of the expanded fan display 700. The actual display area 702 may be those portions of a display membrane 400 having control layer components, display layer components and/or pixels for presenting visual information. In embodiments where the actual display area 702 is substantially the same as that of the entire expanded display 700, both the actual display area 702 and the expanded display 700 may be of the same shape. Alternatively, the actual display area 702 may be of a smaller area and may further be a second shape (e.g., a rectangle, a convex polygon, a concave polygon) inscribed within the larger expanded display configuration 700, or a similar shape of smaller dimensions.

In various embodiments, the display 700 may be integrated with an electronic device 704. The electronic device may be any portable or hand-held device, such as laptop and notebook personal computers, televisions, personal digital assistants, cellular telephones, satellite telephones, electronic document readers and any of a variety of user input devices, such as keyboards. The device 704 may include a display controller for providing display instructions to the display 700. Alternatively, the display 700 may be a standalone device that receives display instructions from an on-board display controller, a display wand, a light pen, a user input device, an on-board wireless receiver or a hard-wired port for receiving display instructions from a remote device.

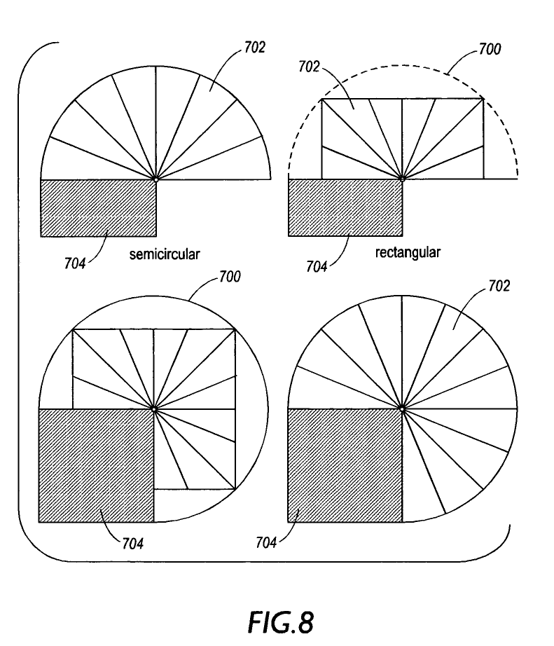

The shape of the electronic device 704 need not always be rectangular as shown, although they are frequently produced in such a configuration. For sake of brevity, only the case of a substantially rectangular electronic device 704 will be specifically addressed herein. It should be readily appreciated that the electronic device 704 may be provided in any of a variety of shapes.

Whereas FIG. 7 shows the pivot point 504 of expanded fan configurations attached substantially at a mid-point of an adjacent edge of an integrated portable electronic device 704, it is readily contemplated that other attachment points along the device 704 are possible. For example, as shown in FIG. 8, an expanded display 700 may extend from a corner of an electronic device 704. Attachment at the corner of a device allows a greater diameter, and thus, a greater display area for the expanded display. This is especially true where a corner-mounted display is retractable or partially retractable into device for storage, and the collapsed display may be retracted along the device's diagonal rather than its shorter length or width. Attachment at the corner also allows the fan display to be expanded to areas greater than 180 degrees of a circle. In various such configurations, the display 700 may be expanded to form any wedge shape up to 270 degrees of a complete circle. Such corner-mounted configurations thus readily allow for an expanded display area that is greater than that of the attached device. It should be readily appreciate that the display 700 may likewise be less than 180 degrees of a circle when partially or fully expanded.

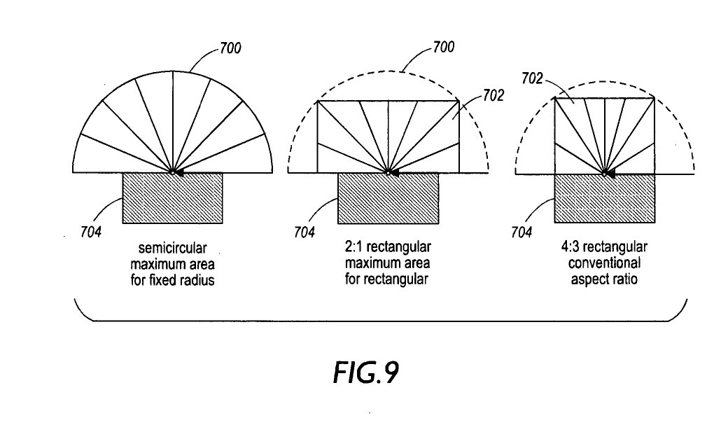

As shown in FIGS. 8 and 9, the expanded display 700, whether mounted on a side or a corner of the device 704, may be longer and/or wider than that of the integrated device 704. In certain embodiments, shown in FIG. 9, the display area may be a larger rectangular area, and may have a 2:1 length-to-width aspect, or a 4:3 length-to-width aspect as are common in current displays. Where the display area 702 is not in a conventional rectangular configuration, conversion of standard display instructions (e.g., by distortion, such as the hyperbolic distortion described in U.S. Pat. No. 5,590,250) may be performed, either by a display controller resident within the display 700 or by the electronic device 704 itself, in order to fully utilize non-standard display areas 702 with existing applications. Such conversion can be applied in any of a number of ways, such as a direct “fisheye” transformation of screen coordinates, or a distortion of the size and layout of graphical objects as described in U.S. Pat. No. 5,590,250.

Although the attachment point has generally been described as at a particular fixed position with respect to the device 704, it is readily contemplated that the attachment point may be moveable along a portion of or even the entire perimeter of the device 704 using appropriate guides that allow the pivot point to slide along the edge of the device and, where necessary, maintain an electrical connection with the device 704.

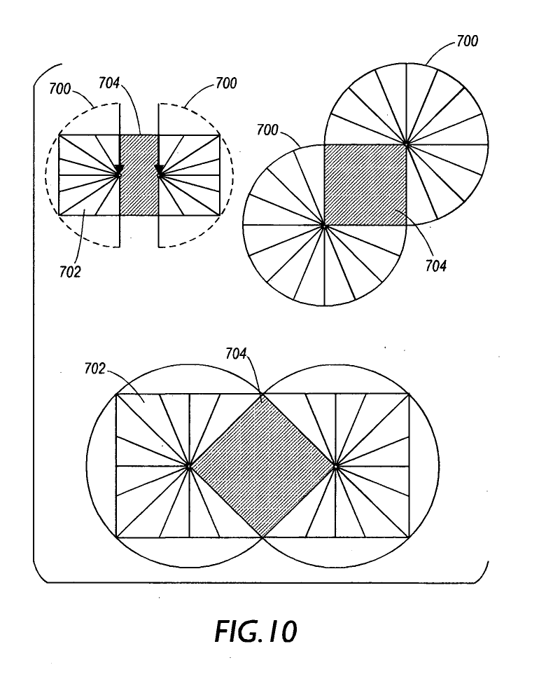

FIG. 10 shows various configurations in which two or more displays 700 may extend from sides or corners of a single electronic device 704. The two displays 700 may provide separate information to a user or may each be sections of a larger display area in which information is displayed continuously from one display 700 to the other. In such configurations, a surface of the integrated device 704 itself may also include a portion of the visual display area in order to provide a continuous visual display area with the two attached displays 700.

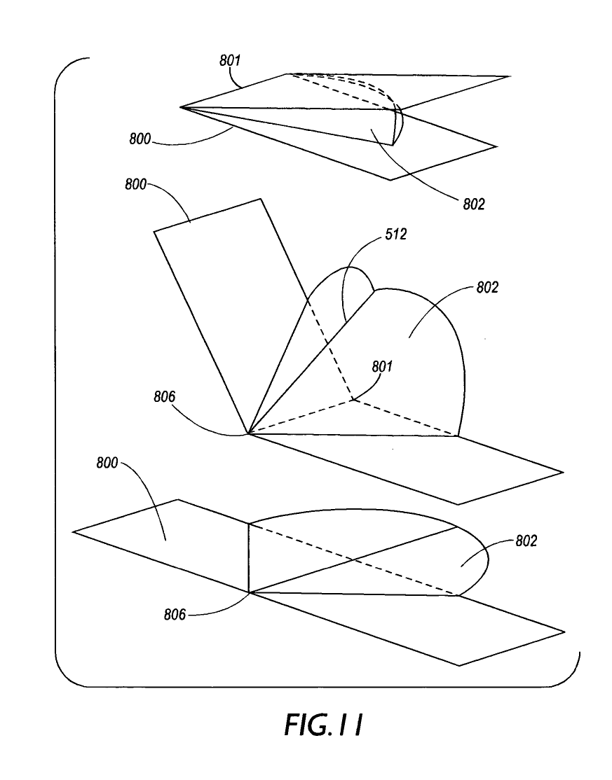

FIG. 11 shows another embodiment of a collapsible display, referred to herein as a “pop-up” configuration, in which two hinged, folding rigid panels 800 are connected to one or more sections 802 of a deformable display membrane 400 that are deformed about one or more axes 512. The sections 802 are fixed to a common pivot 806, which may be fixed at the hinge junction of the two rigid panels 800. When the rigid panels 800 are opened about the hinge, the sections 802 expand to a larger display area and when the rigid panels 800 are closed, the display 802 collapses to a compact area. Many variations of this configuration as possible. Using the embodiment in FIG. 11 as an example, the distinguishing characteristic of a pop-up configuration is that the opening motion of the hinged rigid panels 800 results directly in motion on the part of the one or more sections of a deformable membrane 802 around one or more axes 512, the latter motion resulting from the fact that the one or more sections of a deformable membrane 802 are attached to two or more of the hinged rigid panels 800 and are therefore being pulled in opposing directions. It is not necessary for the one or more sections of a deformable membrane to be attached to the hinged rigid panels precisely as shown in FIG. 11. It is also not necessary for the hinged rigid panels 800 to be fully rigid, as exemplified by the semirigid paper pages in children's pop-up books. It is readily contemplated that more than the two sections 802 of the display may be provided. The sections 802 of the display may be constructed from separate panels that are hinged together by a hinge 801 and open along one or more axes 512. Additionally, one or more support members, such as those described for the fan configuration 500 above, may be provided to support the sections 802. For example, such support members might run behind the body of the display section 802, providing stiffness for the membrane itself, or support members might be placed between the display sections 802 (e.g., along axis 512, rotating around common pivot 806).

FIG. 11 further illustrates two points of similarity between the pop-up configuration and the folding fan configuration of FIG. 5. First, the use of oblique angles in the shape of the display sections 802 allows the pop-up display to collapse into a compact closed configuration, just as the analogous use of oblique angles in the shape of the display sections 510 was key for the folding fan display. Second, recall from FIG. 5 that alternate display sections 510 were rotated 180 degrees through the plane of the display when the folding fan display was opened, and that an analogous rotation by the display sections 802 occurs in FIG. 11 as the pop-up display is opened

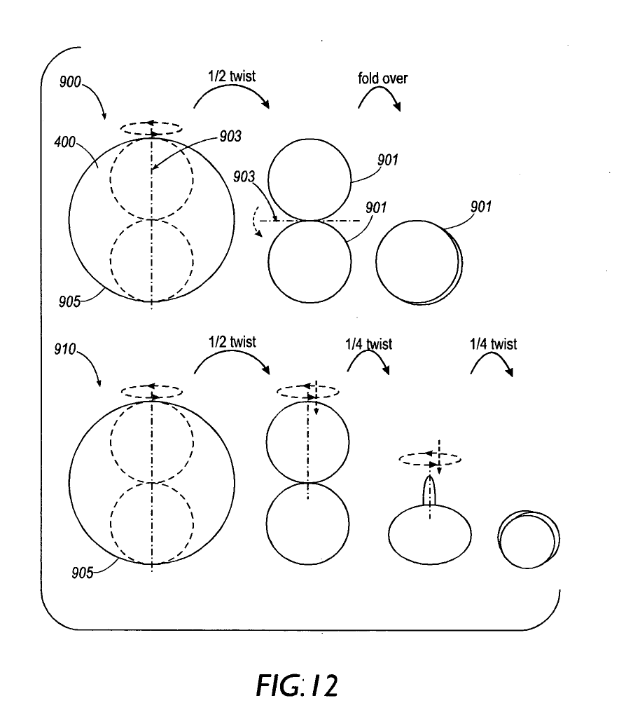

FIG. 12 shows a further embodiment of a collapsible display, referred to herein as a “twist-up” configuration. Twist-up displays are characterized in that they can be collapsed from a larger area 900, 910 by twisting or rotating the larger area about a one or more imaginary axes 903 to form smaller areas 901 with a single, smooth twisting motion. Such twisting may be performed a number of times to form still smaller collapsed areas. When collapsed, the twist-up configuration 900 may form any of a variety of geometric shapes including oval or circular forms. Twisting and untwisting the rim 905 will change the dimensions of the twist-up configuration 900 between the larger areas 900, 910 and the smaller areas 901. As with other configurations described above, twist-up displays may be provided as stand-alone devices or integrated with an electronic device.

The twist-up display may include a semirigid, spring-like rim 905 serving as a support member for the display membrane 400. The rim may be biased along one or more axes 903 such that at least one section of the expanded display area 900 may be collapsed. The semirigid support member 905 supports the display membrane 400 in its expanded configuration; if more strongly spring-like materials are used, the semirigid support member 905 may also tend to force the twist-up display to its expanded configuration (and, conversely, tend to cause the twist-up display to resist being returned to its collapsed configuration). In certain embodiments, the display membrane 400 may be a substantially planar, generally rectangular sheet held in an open configuration by the rim. The actual shape of the expanded rim 905 can range from any class of arcuate or oval shape that substantially spans the area of the display membrane 400, to a closed shape generally following the perimeter of the display membrane 400.

FIG. 12 illustrates that, as the twist-up display is expanded or collapsed, portions of the display membrane 400 are twisted out of the plane of the display and back into the plane of the display. Different sections of the support member 905 can be seen to provide support to different parts of the display membrane 400, e.g., after the first ½-twist step.

Various additional configurations of twist-up display may be adapted from existing known technologies involving collapsible automobile windshield shades, tents and awnings which likewise include semirigid rims attached to a flexible material. Various techniques for expanding and collapsing flexible materials between larger and smaller areas are described in U.S. Pat. Nos. 4,951,333; 5,035,460; 5,452,934; and 5,611,380. (U.S. Pat. No. 5,762,144 describes collapsible automobile windshield shades analogous to the known multiple-axis fold-up displays.) In all of these examples, as in the example shown in FIG. 12, the common element is that there is a semirigid support member, attached at least in part to the outer periphery of the display membrane.

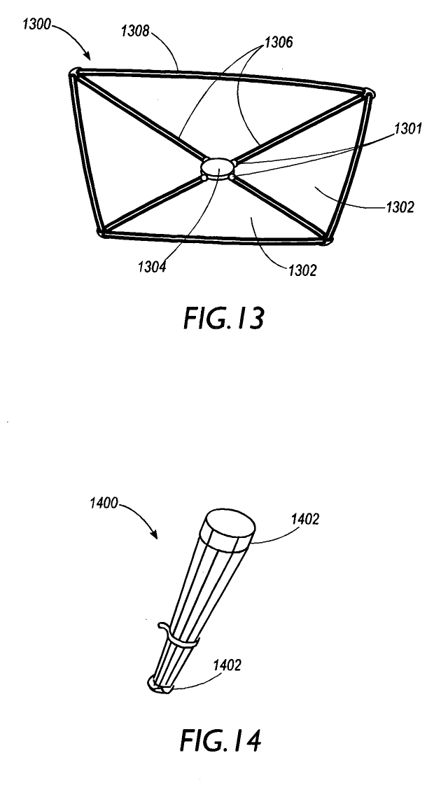

FIG. 13 shows a further embodiment 1300 of a collapsible display, referred to herein as an “umbrella” configuration. The display includes a deformable membrane 1302, a hub 1304, and a plurality of support members 1306 each connected to the hub 1304 and secured to positions along an outer periphery 1308 of the deformable membrane 1302. The plurality of support members 1306 are connected to the hub 1304 by releasable locking joints or hinges 1301, enabling the display 1300 to be releasably locked in an open position where the deformable membrane 1302 is extended by the support members 1306, and to be placed in a closed position where the deformable membrane 1302 is collapsed by the support members 1306.

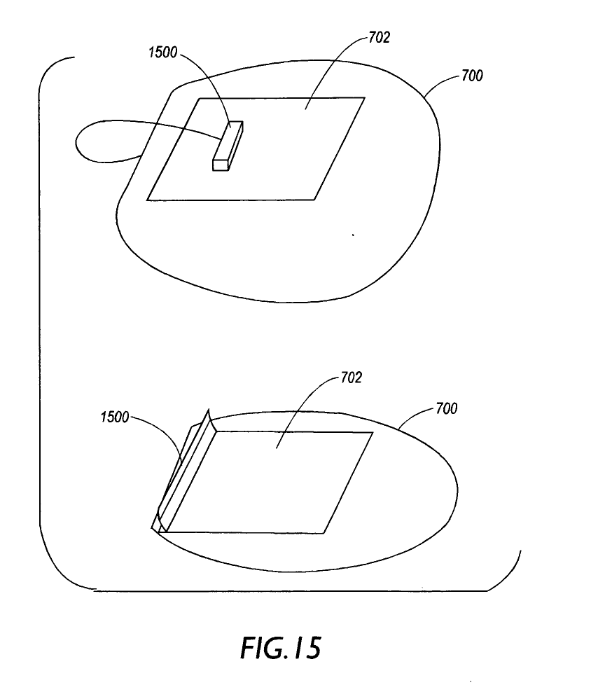

FIG. 14 shows the umbrella configuration in its collapsed configuration 1400. In an instance of an umbrella display 1300 where the expanded area has a square shape and each support member 1306 may be said to have unit length, then each edge of the expanded display 1300 has a length of sqrt(2), or approximately 1.4, times the length of a given support member. Since the length of the support member defines the maximum dimension of the collapsed display 1402, we see that the umbrella configuration also enables the construction of displays that are larger in more than one dimension when expanded than their maximum dimension when collapsed.

In the transition from the expanded configuration of FIG. 13 to the collapsed configuration of FIG. 14, it can clearly be seen that the support members 1306 support the display membrane 1302 as the umbrella display changes from its linear collapsed configuration to its final planar expanded configuration—that is, as the display membrane is deformed from being substantially perpendicular to the plane of the display to being within the plane of the display. The same is true when the umbrella display is returned to its collapsed configuration.

Various additional configurations of umbrella displays may be adapted from existing known technologies involving collapsible automobile windshield shades which likewise include hubs attached to a flexible material using support members. Various techniques for expanding and collapsing flexible materials between larger and smaller areas are described in U.S. Pat. Nos. 6,095,230 and 6,135,191. In all of these examples, as in the example shown in FIG. 13 and FIG. 14, the common element is the fact that the support members attach to a hub and are attached at least in part to the outer periphery of the display membrane.

FIG. 15 shows an embodiment of a collapsible display 700 where display pixels are activated by a display wand 1500 or the like. The display wand may be any device that generates an electric field or other signal to activate particular pixels, and can be moved over the display area 702 to create visual information. The display wand 1500 may be affixed to the display area 702 or may be detached therefrom. The display wand 1500 may have appropriate sensors and the like for determining its position on the display area and activating display pixels accordingly. The display wand 1500 may also include a passive tracking means by which an active tracking means (within, e.g., an electronic device attached to the display or the collapsible display itself) can determine the position of the display wand 1500 on the display area. This tracking information can then be used to provide appropriate display instructions for the display wand 1500, which in turns allows the display wand 1500 to activate display pixels accordingly.

Various technologies may be used for the display wand 1500, such as those described in U.S. Pat. Nos. 5,389,945 and 6,473,072. For example, in U.S. Pat. No. 5,389,945, a hand-held display wand, connected to a computing device and containing a linear array of addressing electrodes, is passed over a gyricon display sheet to write information transmitted from the computing device onto the gyricon display sheet; registration marks are provided on both sides of the display sheet for cooperating with suitable sensors (such as optical or magnetic) in the display wand in order to track the wand speed and alignment.

Additionally, the display 700 may be touch-sensitive or be activated by a stylus in a similar manner to PDAs. For example, in U.S. Pat. No. 5,389,945, a battery-operated stylus having about 100 volts output in series with a very large resistor, is used to write upon a gyricon display sheet in a manner comparable to the addressing scanning array, i.e., by causing the gyricon bails to rotate. These known display wand techniques can be applied directly to the collapsible displays of the current invention. However, it is also possible to combine these (and other related display wand techniques) advantageously with the additional structural elements of the current invention. For example, in embodiments of the current invention that include a pivot, such as those having the folding fan or brisé fan configurations, the display wand can be attached to the pivot. This enables the display wand to be passed over or under the expanded collapsible display with a single, rapid and convenient “windshield wiper” motion. It also enables the display wand to be shielded by, or even physically combined with, a rugged external case element which is attached to the pivot (e.g., as the uppermost or lowermost element of a brisé fan configuration). As another example, a display wand mounted on a pivot can be added near the point 806 of the pop-up display of FIG. 11 so that the pop-up portion of the display 802 can be addressed in a manner similar to that just described for the fan display configurations.

Depending on the technologies available to a particular manufacturer to implement the structural substrate of the display and the control layer of the display, embodiments based on a display wand will have certain advantages with respect to mechanical reliability and usefulness as compared to embodiments that do not use a display wand. It is known that particular technologies for the display layer, such as those based on gyricon, are relatively robust with respect to repeated deformation (e.g., bending). In the case of gyricon, the mechanical elements surrounding the twisting-ball display elements are composed of fluids or highly elastic materials (such as thin sheet plastic) and so the display layer is typically undamaged by mechanical stress when deformed. On the other hand, addressing circuitry in the control layer will include conductors (such as copper traces) and possibly semiconductors (such as flexible transistors).

Different materials will have different types of failure modes caused by repeated deformation. For example, if the addressing elements are constructed from materials which are themselves inadequately elastic, repeated deformation may cause them to fail. As another example, if the addressing elements are attached to structural substrate materials which are inadequately compliant (in the sense described in Z. Suo et al., “Mechanics of rollable and foldable film-on-foil electronics,” Appl. Phys. Lett. 74(8), 1999, 1177-1179), the control layer circuitry may fail due to delamination.

These examples are not intended to be representative or exhaustive, but are intended only to illustrate that use of a display wand to address the pixels in the display layer of the deformable membrane (as opposed to addressing the pixel elements using an electronic control layer attached to the structural substrate of the deformable membrane) can avoid situations where the control layer determines the overall failure rate of the collapsible display instead of the display layer. This is important if the display layer materials available to a manufacturer are more robust in terms of deformation than the available control layer materials.

Although the best methodologies of the invention have been particularly described in the foregoing disclosure, it is to be understood that such descriptions have been provided for purposes of illustration only, and that other variations both in form and in detail can be made thereupon by those skilled in the art without departing from the spirit and scope of the present invention, which is defined first and foremost by the appended claims.

1. A collapsible display deformable between an expanded configuration with a greater visible area and a collapsed configuration with a smaller visible area, the collapsible display comprising:
at least three collapsible sections, including at least one display section, coupled such that when the collapsible display is in the expanded configuration, each of the collapsible sections has a first end adjacent to another of the collapsible sections, the adjacent ends substantially aligned along an axis, and each display section further has a second end that is substantially opposite to the first end and substantially oblique relative to the first end.

2. The collapsible display of claim 1, further comprising
a pivot to which each display sections is connected and about which each display section can rotate.

3. The collapsible display apparatus of claim 2, wherein at least one of the display sections is rotatable between:
a first position about the pivot in which the display section overlaps significantly with another of the display sections such that the display sections occupy the smaller visible area, and
a second position about the pivot where the display sections occupy the greater visible area.

4. The apparatus of claim 2, wherein at least one of the display sections is rotatable between a first position about the pivot in which the collapsible display occupies the smaller visible area, and a second position about the pivot where the collapsible display occupies the greater visible area.

5. The display apparatus of claim 1, further comprising
a hinge element for enabling the display sections to rotate on an axis;
two opposing panels;
an additional hinge element for connecting adjacent sides of the two opposing panels and further for allowing the two opposing panels to rotate between an open position and a closed position, wherein the display sections are coupled to the two opposing panels such that the display sections are collapsed when the two opposing panels are in the closed position and the display sections are expanded when the two opposing panels are in the open position.

6. The display apparatus of claim 1, further comprising
a section of a flexible display membrane secured to each of the display sections.

7. The display apparatus of claim 6, said display membrane comprising an electric paper.

8. The display apparatus of claim 6, further comprising an electronic device for providing display instructions to the display membrane.

9. The display apparatus of claim 8, said electronic device comprising at least one of:
a portable computing device, a television, a wireless communication device, a cellular telephone, a satellite telephone, a display controller, a wireless receiver and a personal digital assistant.

10. The display apparatus of claim 8, said electronic device comprising a display wand for addressing the visual display elements of at least a portion of the display membrane.

11. The display apparatus of claim 8, wherein the display section extends from one of: a side and a corner of the electronic device.

12. The apparatus of claim 8, wherein the collapsed display membrane is at least partially retractable into a body of the electronic device.

13. The display apparatus of claim 6, the display membrane comprising a plurality of pixels forming a visual display area having a display layer.

14. The display apparatus of claim 13, the display membrane further comprising a control layer for addressing the plurality of pixels.

15. A collapsible display deformable between an expanded configuration with a greater visible area and a collapsed configuration with a smaller visible area, the collapsible display comprising:
a flexible display membrane, and
at least one support member connected to the flexible display membrane, for supporting a portion of the flexible display membrane during an out-of-plane deformation.

16. The display apparatus of claim 15, further comprising
a pivot, and each support member connected to the pivot about which the support member can rotate.

17. The display apparatus of claim 15, said at least one support member is rotatable between a first position about the pivot, in which the portion of the flexible display membrane overlaps significantly with a second portion of the flexible display membrane such that the flexible display membrane occupies a smaller visible area, and a second position about the pivot in which the first and second portions of the flexible display membrane occupy a greater visible area.

18. The display apparatus of claim 15, further comprising
two opposing panels; and
a hinge element for connecting adjacent sides of the two opposing panels and further for allowing the two opposing panels to rotate between an open position and a closed position, wherein the flexible display membrane is secured to the two opposing panels at a plurality of positions such that the at least one display section is collapsed when the two opposing panels are in the closed position and the at least one display section is expanded when the two opposing panels are in the open position.

19. The display apparatus of claim 15, wherein the at least one support member is secured to positions along an outer periphery of the flexible display membrane

20. The display apparatus of claim 15, further comprising
a hub, wherein the at least one support member is connected to the hub at a first end and secured to positions along an outer periphery of the flexible display membrane at a second end such that each support member is rotatable between a first position about the hub where each support member is substantially parallel to each other and the flexible display membrane is collapsed to a smaller visible area and a second position about the hub where the flexible display membrane forms at least a portion of a visible area having a greater visible area.

21. The display apparatus of claim 15, further comprising:
a deformable rim forming an outer periphery of the flexible display membrane, wherein the at least one support member is secured to positions along the deformable rim and the deformable rim is biased to allow a section of the flexible display membrane to be twisted about at least one axis to form the collapsed configuration and untwisted about the at least one axis to form the expanded configuration.

22. The display apparatus of claim 15, further comprising an electronic device for providing display instructions to the display membrane.

23. A display apparatus, comprising:
a display membrane having at least one individually-deformable section, wherein when an individually-deformable section is collapsed, the collapsed section forms a first geometric configuration having a first area, and when the collapsed section is expanded, the expanded section forms a second geometric configuration having a second area greater than the first area.

24. The display apparatus of claim 23, comprising:
a plurality of support members for supporting the display membrane, each support member having a first end connected to a pivot point about which the support member may rotate to expand and collapse the at least one individually-deformable sections of the display membrane.

25. The display apparatus of claim 24, each of the expanded sections forming a fan-shaped display.

26. The apparatus of claim 23, further comprising:
a deformable rim around the section of the display membrane, wherein the deformable rim is biased to allow the section to be twisted about at least one axis to form a collapsed position and untwisted about the at least one axis to form a visual display area.

27. The display apparatus of claim 23, further comprising:
two opposing panels;
a hinge for connecting adjacent sides of the two opposing panels for allowing the two opposing panels to rotate between an open position and a closed position; and
a section of the display membrane connected to at least one of the opposing panels, wherein the section is deformed when the two opposing panels are in the closed position and the section is unfolded when the two opposing panels are in the open position to form a display area.

28. The apparatus of claim 23, further comprising:
a display hub for connecting the at least one individually deformable section of the display membrane; and
at least one support member for expanded and collapsing the at least one individually-deformable section between the first and the second geometric configurations about the hub.

29. A method for operating a foldable display, comprising:
rotating a support member for a display from a first position to a second position about a pivot to expand at least a portion of a visual display; and
rotating the support member from the second position to the first position to collapse the visual display.

30. A method for operating an electronic display, comprising:
unfolding a pair of opposing hinged panel sections, at least one of the hinged panel sections connected to a section of a display membrane that is unfolded in an opposite position from the pair of opposed hinged panel sections to form a display area; and
folding the pair of opposing hinged panel sections, thereby collapsing the display area.
